(19) United States
(12) Patent Application Publication
(10) Pub. No.: US 2016/0263523 A1
(43) Pub. Date: Sep. 15, 2016

(54) EXHAUST GAS REFORMATION USING HUMIC SUBSTANCES

(71) Applicants: Don Calvin Van Dyke, Orem, UT (US); Asa Staples Nielson, Orem, UT (US)

(72) Inventors: Don Calvin Van Dyke, Orem, UT (US); Asa Staples Nielson, Orem, UT (US)

(21) Appl. No.: 15/067,017

(22) Filed: Mar. 10, 2016

Related U.S. Application Data
(60) Provisional application No. 62/131,006, filed on Mar. 10, 2015.

(51) Int. Cl. B01D 53/78; F01N 3/20

(52) U.S. Cl. CPC B01D 53/78; F01N 3/2066; F01N 2610/01; F01N 2610/1433; F01N 2610/1453; B01D 2251/70

(57) ABSTRACT

Disclosed herein is one embodiment of a method for reforming an exhaust gas stream. The method includes providing a fluid having humic substances and combining the fluid with the exhaust gas stream. The exhaust gas stream includes emissions from a combustion process. The humic substances in the fluid react with the emissions in the exhaust gas stream to yield reformed emissions byproducts.

### CROSS-REFERENCES TO RELATED APPLICATIONS

This application claims the benefit of U.S. Provisional Patent Application No. 62/131,006 entitled “EXHAUST GAS REFORMATION USING HUMIC SUBSTANCES” and filed on Mar. 10, 2015 for Don Calvin Van Dyke, which is incorporated herein by reference.

### FIELD

This disclosure relates generally to exhaust gas reformation, and more particularly to using humic substances in exhaust gas aftertreatment systems.

### BACKGROUND

Emissions regulations for power plants and internal combustion engines have become more stringent over recent years. Environmental concerns have motivated the implementation of stricter emission requirements. Governmental agencies, such as the Environmental Protection Agency (EPA) in the United States, carefully monitor the emission quality of power plants, internal combustion engines, and other processes and set acceptable emission standards. Consequently, the use of aftertreatment systems on power plant and engine exhaust systems is widespread.

### SUMMARY

The subject matter of the present application has been developed in response to the present state of the art, and in particular, in response to the shortcomings of exhaust gas aftertreatment systems. Accordingly, the subject matter of the present application has been developed to provide an exhaust gas aftertreatment system that employs humic substances that overcome at least some of the above-discussed shortcomings of prior art systems and methods.

Disclosed herein is one embodiment of a method for reforming an exhaust gas stream. The method includes providing a fluid having humic substances and combining the fluid with the exhaust gas stream. The exhaust gas stream includes emissions from a combustion process. The humic substances in the fluid react with the emissions in the exhaust gas stream to yield reformed emissions byproducts.

In one implementation, the fluid having humic substances is provided in a liquid form. In such an implementation, combining the liquid with the exhaust gas stream includes first vaporizing the liquid to form a vapor stream that comprises humic substances and introducing the vapor stream into the exhaust gas stream. In one implementation, the combustion process is a power plant. In another implementation, the combustion process is an internal combustion engine.

According to one implementation, the method further includes removing the reformed emissions byproducts from the exhaust gas stream. In one implementation, providing the fluid having humic substances includes extracting a liquid effluent from organic compost material. Extracting the liquid effluent from organic compost material may include providing an organic compost material, combining the organic compost material with a crop, and subsequently heating the organic compost material. Extracting the liquid effluent from organic compost material may further include subsequently heating the organic compost material, combining the organic compost material with water, and subsequently extracting the fluid comprising humic substances. In such an implementation, the crop is mushroom spores and mycelia. The heating step, according to one implementation, is performed while the organic compost material is still combined with soil in which the crop is or was planted. The heating step may raise the organic compost material to at least 170° F. In another implementation, the heating step includes heating the organic compost material to at least 200° F. In yet another implementation, the heating step includes heating the organic compost material to at least 220° F.

Also disclosed herein is another embodiment of a method for reforming an exhaust gas stream. The method includes providing an organic compost material, combining the organic compost material with a crop, and subsequently heating the organic compost material. Still further, the method subsequently includes combining the organic compost material with water; subsequently extracting the fluid having humic substances, and combining the fluid having humic substances with the exhaust gas stream. As mentioned above, the exhaust gas stream includes emissions from a combustion process. The humic substances in the fluid react with the emissions in the exhaust gas stream to yield reformed emissions byproducts.

Also disclosed herein is an embodiment of a system for reforming an exhaust gas stream. The system includes a vaporizer configured to vaporize a liquid having humic substances to form a vapor stream that has humic substances. The system further includes a scrubber in fluid receiving communication with the exhaust gas stream. The scrubber is configured to wash the exhaust gas stream with the vapor stream to yield reformed emissions byproducts.

In one implementation, the vaporizer is a nebulizer, an aspirator, an atomizer, a spray nozzle, an expansion valve, or a venturi pump. In another implementation, the scrubber is configured to yield reformed emissions byproducts that precipitate out of the exhaust gas stream and/or that are insoluble in an aqueous liquid. The system may further include a separator configured to remove the reformed emissions byproducts from the exhaust gas stream. The scrubber may also include a heater configured to heat the exhaust gas stream and the vapor stream having humic substances to at least about 170° F. In another implementation, the heater is configured to heat the exhaust gas stream and the vapor stream having humic substances to at least about 220° F.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the disclosure may be more readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the subject matter of the present application will be described and explained with additional specificity and detail through the use of the accompanying drawings, in which:

FIG. 1 is a schematic flow chart diagram of another embodiment of a method for producing an aqueous liquid containing humic acid and fulvic acid.

FIG. 2 is a schematic flow chart diagram of one embodiment of a method and system for producing an aqueous liquid containing humic acid and fulvic acid;

FIG. 3 is a schematic flow chart diagram of another embodiment of a method and system for producing an aqueous liquid containing humic acid and fulvic acid, the method and system including a slurry mixture and a separator;

FIG. 4 is a schematic flow chart diagram of another embodiment of a method and system for producing an aqueous liquid containing humic acid and fulvic acid, the method and system including a slurry mixture, a filter, and a separator;

FIG. 5 is a schematic flow chart diagram of another embodiment of a method and system for producing an aqueous liquid containing humic acid and fulvic acid; and

FIG. 6 is a schematic block diagram of one embodiment of an aftertreatment system that includes a scrubber that utilizes humic substances to wash an exhaust gas stream;

FIG. 7A is a schematic flow chart diagram of one embodiment of a method for reforming an exhaust gas stream; and

FIG. 7B is a schematic flow chart diagram of another embodiment of a method for reforming an exhaust gas stream.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

The present disclosure includes details regarding systems and methods for reforming an exhaust gas stream using humic substances. Humic substances are defined herein as substances that include fulvic and/or humic acid. Fulvic acid is a naturally-occurring organic product derived from humus, the organic material in soils produced by the decomposition of organic matter. In addition to fulvic acid, humus also contains humic acid and humin. These humic substances are active components in soil and provide numerous benefits for plants. Fulvic acid is the most plant-active of the humic substances.

Humic substances, including fulvic acid and humic acid, are largely found in pre-historic deposits of lignite, a soft, brownish coal that has developed from peat through bacterial action over millions of years. Smaller quantities are also found naturally in soil. Thus, while humic substances are naturally-occurring, extracting them from natural sources has proved to be complex and problematic. This is particularly true for extraction of fulvic acid from natural sources. For example, most traditional methods of extraction of fulvic acid in commercial quantities generally require extraction from lignite or coal. Other known techniques involve extraction of humic substances from humic acid bearing mineral ores. These methods generally require the use of acids and bases to leech out the desired components.

Another source of humic substances is organic material. For example, humic substances may be extracted from an organic compost material. In such an embodiment, liquid is combined with the organic compost material and the liquid run-off/liquid effluent from the organic compost mixture is collected. The organic compost material from which the humic substance containing effluent is extracted may be an organic material that undergoes “composting”. As generally defined herein, the term “composting” refers to the decay and decomposition, whether natural or assisted with chemical or microbial additives, of organic matter. Thus, according to one embodiment, organic matter is a precursor to the organic compost material from which humic substances are extracted.

Any organic substance may be a suitable source of organic matter to generate the organic compost material. Examples of suitable organic matter for composting include, but are not limited to, human biosludge, human waste, animal waste, animal carcasses, tires, food, cellulosic materials, lignin, construction and demolition materials, plant matter, wood chips, straw, peat, cardboard, paper, coffee grounds, coir, cocoa shell, garden waste, leaves, grass, seaweed, manure, mushrooms, tree bark, eggshells, and the like. In one aspect of the extraction system and method, the organic matter contains up to about 90% cellulose, such as grass, algae, cotton, wood pulp, wood chips, paper, cardboard, straw, and the like. One of the benefits of using cellulosic organic matter as a source material for production of humic substances instead of lignite is that the cellulose increases the quantity and production time of humic substances, and is a precursor to and preliminary component of fulvic acid.

The composting may be aerobic or anaerobic. Aerobically generated organic compost material is especially beneficial in the production and extraction of fulvic acid. One of the byproducts of aerobic composting is carbon dioxide, which is trapped in the organic compost material and therefore can become a part of the extracted aqueous liquid effluent. Anaerobic composting typically produces nitrogen and ammonia as byproducts, but the ammonia can be easily converted into ammonium nitrate, a common component of fertilizers, by those of skill in the art. Thus, the resulting aqueous liquid effluent may not include only humic substances, such as fulvic acid and humic acid, but also may include ammonium nitrate.

In one embodiment, copper sulfate may be added to the effluent as a treatment to kill pathogens and stabilize the effluent. In another embodiment, the effluent is treated by adding microbes selected for their capacity to kill harmful pathogens. In another embodiment, the treatment step comprises one or more heat processes to kill pathogens, including, but not limited to, pasteurization or thermophilic composting. These heat processes may occur during the composting process, or they may occur after collection of the effluent from the organic compost mixture, or both.

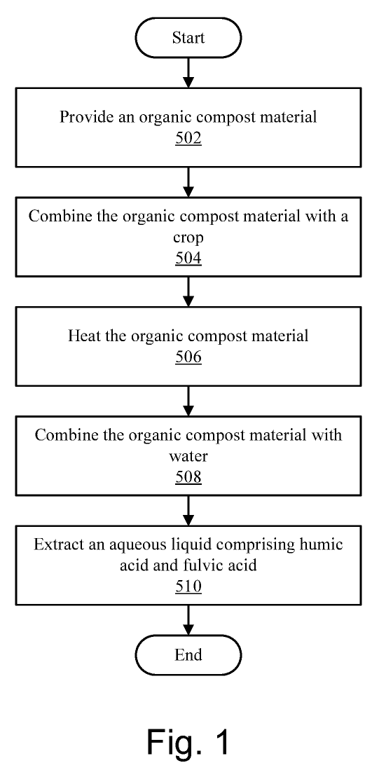

FIG. 1 is a schematic flow chart diagram of one embodiment of a method for producing an aqueous solution of fulvic acid and humic acid. As described above, it is expected that other extraction methods and/or other sources may be utilized in order to provide a fluid containing humic substances. The method includes providing 502 an organic compost material, combining 504 the organic compost material with a crop, heating 506 the organic compost material, 508 combining the organic compost material with water, and extracting 510 an aqueous liquid that includes humic substances, such as fulvic acid and humic acid.

The provided 502 organic compost material, as described above with reference to FIG. 1, may include various organic materials, such as cellulosic materials, waste, manure, etc. In one embodiment, the organic compost material specifically includes wheat straw and a nitrogen source. The nitrogen source may be a fertilizer containing nitrogen or it may be manure, such as horse manure, chicken manure, turkey manure, etc. Also, providing 502 the organic compost material may include allowing the organic materials to aerobically compost for several weeks. In one embodiment, the aerobic composting process includes natural internal heating that raises the temperature of the organic compost material to at least 130° F.

In another embodiment, in order to facilitate the aerobic composting process, external heat may be applied to the organic compost material to raise the temperature of the compost material. The aerobic composting process may include multiple phases or steps of mixing the organic compost mixture in order to ensure proper oxygen interaction with the composting process.

The method continues by combining 504 the organic compost material with a crop. The crop may be any vegetable, fruit, tree, fungus, or plant that would benefit from the specific organic compost material. For example, mushrooms have a specific need for organic compost material because mushrooms (fungi in general) do not carry out the process of photosynthesis and thus all of their nutrients, energy, and food must be supplied to them via the soil they are growing in.

A crop may include crop starters, such as seeds, bulbs, spores, and the like. For example, mushrooms grow from mycelium, which grow from mushroom spores. Plants, such as vegetables, grow from seeds. Thus, a crop may include already planted crops that are already growing or crops may include crop starters such as seeds and spores. In one embodiment, combining 504 the organic compost material with a crop may include applying the compost to an already planted crop starter. For example, garden vegetables may be planted and then a layer of organic compost material may be added on top of the soil containing the vegetable seeds. In another embodiment, combining 504 the organic compost material with a crop may include applying to and/or mixing the organic compost material with the soil before the crop starters are planted. In yet another embodiment, the crop starters may be planted directly into the organic compost material or the crop starters, the soil, and the organic compost material may be all mixed together before planting.

The method continues by heating 506 the organic compost material. In one embodiment, the organic compost material is heated 506 while a portion of the crop is still growing. In another embodiment, the crop has been substantially harvested and the leftover/spent organic compost material is heated. In another embodiment, several rounds of crops have been planted in the same batch of organic compost material before the organic compost material is heated 506. Accordingly, the method includes heating 506 the organic compost material while the organic compost material is still combined with the soil in which the crop is/was planted.

The heating 506 may be accomplished via any recognizable heating procedure. For example, steam-heating may be used to increase the ambient temperature around the organic compost material. In another embodiment, a heat exchanger may be used to substantially heat the organic compost material or a propane heater may be used to heat the organic compost material. The heating 506 may be inductive heating, convection heating, radiation heating, etc.

In one embodiment, the heating 506 causes the organic compost material to rise to a temperature in the range of between about 100° F. and 300° F. In another embodiment, the compost material rises to a temperature of between about 170° F. and 250° F. In another embodiment, the compost material rises to a temperature of about 200° F. In another embodiment, the heating 506 raises the organic compost material to a temperature of about 220° F.

The heating 506 step may benefit the organic compost material in several ways. For example, the heating 506 step may substantially sterilize, sanitize or pasteurize the organic compost material. In one embodiment where the organic compost material was combined with a mushroom crop, the heating 506 may substantially kill any remaining microbes or mushroom spores. The dead microbes/spores may result in a higher concentration of fulvic acid and humic acid in the organic compost mixture than would be present if the heating process were not applied. Spent compost generally includes dormant or dying microbes/spores, however, the heating process substantially kills the remaining microbes thus increases the yield, or at least the solubility/extractability, of the organic acids (humic and fulvic). In one embodiment, the unique growth process of mycelia/mushrooms (no photosynthesis) may contribute to the increased fulvic acid and humic acid content in the spent organic compost material, regardless of whether heating was applied or not.

In another embodiment, the heating 506 may beneficially prepare and/or condition the spent organic compost material for subsequent extraction steps. The organic acids present in the spent organic compost material may be affected by the heating 506 process in such a way as to facilitate their solubility in water. For example, the heating 506 may generally increase the overall polarity of the humic acid and fulvic acid contained within the spent organic compost material, which would promote the solubility of the molecules.

The final two steps in the method, combining 508 the organic compost material with water and extracting 510 an aqueous liquid comprising humic acid and fulvic acid, are described below.

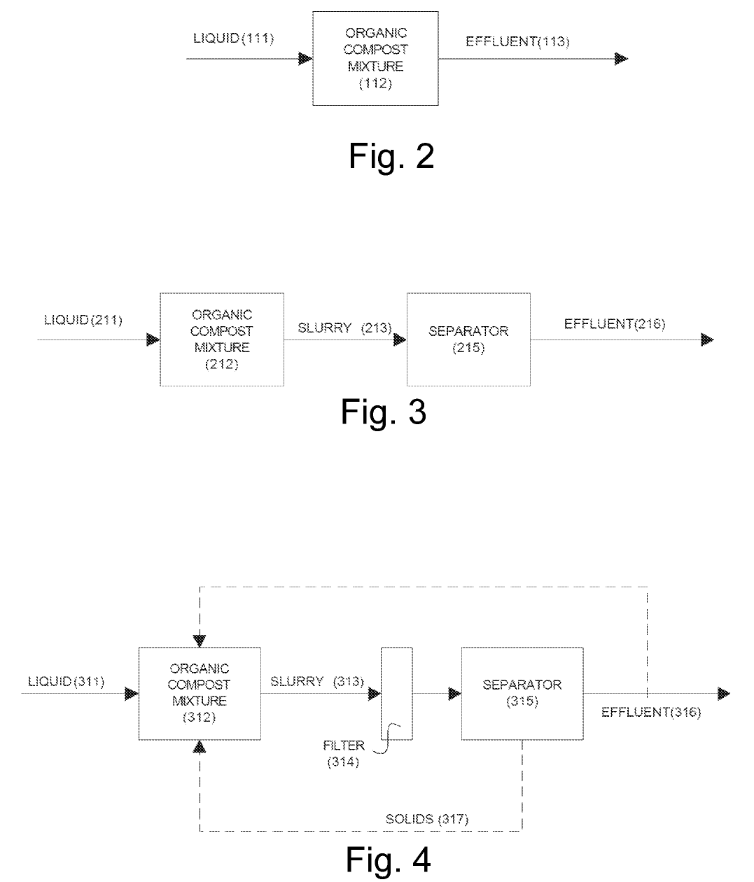

FIG. 2 is a schematic flow chart diagram of one embodiment of a method and system for producing an aqueous liquid containing humic acid and fulvic acid. In one embodiment, the organic compost material 112 may be formed into a compost windrow. A windrow is a long heap or pile of organic matter and/or organic compost material, often in a substantially triangular or mounded shape, for composting of the organic matter into organic compost material. While windrows may be of any shape or size, they are often hundreds of feet long and several feet tall. The size, shape, and contents of the windrow can be selected by those of skill according to the desired composting process parameters.

The liquid 111 combined with the organic compost material 112 can be any type of liquid in which fulvic acid can dissolve. In one embodiment, the liquid 111 is water, which dissolves fulvic acid and also provides moisture to the organic compost material 112 necessary for any microbes in the organic compost material 112 to carry out the composting process. However, the liquid 111 may be any liquid or solution capable of dissolving fulvic acid.

In one aspect, the liquid 111 combined with the organic compost material 112 is ionic water, which also aids in stabilizing and killing harmful pathogens in the organic compost material 112. In one embodiment, the water 111 is substantially neutral, non-processed, non-treated water. For example, the water 111 may be process water from an irrigation source or the like.

The water 111 and/or the aqueous liquid extract 113 may also include useful and beneficial components, such as molecules for the treatment of harmful pathogens, components to aid in the composting or extracting processes, or as additives as may be desired in the final effluent product. For example, in one embodiment essential oils may be added to the water 111 or added to the aqueous liquid 113 to deodorize the smell of the liquid or to otherwise mask the natural odor of the aqueous liquid by replacing it with another more pleasant/agreeable odor. For example, the oil extracted from Lavandula angustifolia (“Lavendar”) has a floral/herbaceous smell that can mask the odor of the extracted aqueous liquid 113.

The liquid 111 can be added to the organic compost material 112 by various methods. In one embodiment, the liquid 111 is sprayed or applied to the surface of the organic compost material 112. This method is often used when the organic compost material 112 is a windrow. In another embodiment, the liquid 111 is added to the organic compost material 112 by mixing it with the organic compost material 112 in a mixer or other apparatus configured for mixing solids and liquids.

The liquid 111 can be added to the organic compost material 112 all at once, or at different times and intervals. The composting process usually requires some moisture content, so as the composting progresses the liquid 111 may need to be added periodically to ensure that the organic compost material 112 has the necessary moisture content. In another embodiment, the liquid 111 is added to the organic compost material 112 in a mixer or other conduit that mixes the two components.

The quantity of liquid 111 added to the organic compost material 112 can vary, and can be determined based on a number of different factors. In one aspect, the liquid 111 added to the organic compost material 112 will be determined by the composting process requirements. The amount of liquid 111 added can also vary depending on the moisture content found in the organic compost material 112. In one aspect, where water is used as the liquid 111, the ratio of water to organic compost material 112 is approximately one-to-one 1:1 by weight.

In another embodiment, the quantity of liquid 111 added is the amount necessary to saturate the organic compost material 112. In yet another embodiment, the amount of liquid 111 added to the organic compost mixture exceeds the saturation level of the organic compost material 112, thus resulting in excess or waste liquid runoff. The amount of liquid 111 to be added can vary depending on the desired amount of excess or waste runoff, as well as on the desired concentration of humic substances, including fulvic acid, in the resulting aqueous liquid effluent 113.

The liquid component (not shown) of the organic compost material 112 can be extracted in a number of different methods. In one embodiment, the liquid component is extracted by collecting the liquid component percolating through the organic compost material 112. The liquid component may percolate naturally through the organic compost material 112, such as by gravity. In another embodiment, percolation may be induced, such as be adjusting ambient pressure, temperature, or humidity. In another embodiment, percolation may be induced by adding liquid 111 to the organic compost material 112 in an amount that exceeds the saturation level of the organic compost material 112. When the organic compost material 112 is saturated, the liquid 111 added in excess of the saturation level cause excess liquid in the organic compost material 112 to percolate through and from the organic compost material 112.

The percolating aqueous liquid effluent 113 may then be collected by any means known to those of skill in the art, such as by allowing the aqueous liquid effluent 113 to flow or drip into or through a defined channel, collecting in a receiving tank, or by pumping. Indeed, any process or technique known to those of skill in the art can be employed to collect or gather effluent 113 from the organic compost material 112.

FIG. 3 is a schematic flow chart diagram of another embodiment of a method and system for producing an aqueous liquid containing humic acid and fulvic acid, the method and system including a slurry mixture and a separator.

In another embodiment, shown in FIG. 3, the liquid component of the organic compost mixture 212 is collected from a slurry 213 created by adding liquid 211 to organic compost mixture 212 according to the methods previously described. The slurry 213 is also an organic compost mixture. The liquid component is separated from the solid components by means of a separator 215. Suitable separators 215 generally include any type of apparatus capable of separating solids from liquids. Examples of a suitable separator 215 include, but are not limited to, a centrifuge, belt press, filter press, membrane press, or the like, or any combination of them. Once the slurry 213 is added into the separator 215, the separator 215 separates the solid components from the liquid component. The separated liquid component thus becomes the aqueous liquid effluent 216, which contains humic substances, including fulvic acid and humic acid.

In one embodiment, the separator 215 comprises a centrifuge. Typically, a stationary or continuous centrifuge will provide suitable separation of the liquid component from the solid components. Continuous centrifuges allow the continuous addition of slurry 213, the continuous removal of the liquid component, and the discontinuous, semicontinuous or continuous removal of the solid components. These types of centrifuges include, but are not limited to, tubular bowl centrifuges, continuous scroll centrifuges, and continuous multichamber disk-stack centrifuges. Semi-continuous centrifuges may also be used. Indeed, any type of centrifuge that allows the separation of solids from liquids may achieve the desired results. Other possible centrifuges include basket centrifuges, disk centrifuges, high speed centrifuges, industrial centrifuges, laboratory centrifuges, and ultracentrifuges.

In another embodiment of the extraction method, the separator 215 comprises a belt press. A belt press is generally a dewatering device utilizing two opposing synthetic fabric belts, revolving over a series of rollers to squeeze liquid from the slurry 213. The belt press dewaters the slurry 213 by applying an increasing surface pressure to the slurry 213 as it passes between moving belts and/or a series of press rollers. While most belt press processes are intended to capture the solids while merely reusing or disposing of the waste liquid, in the extraction process the liquid component drawn off from the slurry 213 by the belt press is captured as the desired effluent product 216. Any type of belt press that separates liquids from solids is suitable for the extraction process.

In another embodiment, the separator 215 comprises a filter press. A filter press is beneficial for use with the extraction method because it is a highly efficient, compact, dewatering device for separating solids from liquid slurries. In yet another embodiment, the separator 215 comprises a membrane press. Any type of filter press or membrane press that separates liquids from solids is suitable for the extraction process. Indeed, any process or apparatus known to those of skill in the art for separating liquids from solids may be used in the extraction process and system.

Regardless of the type of separator 215 used, the resulting aqueous liquid effluent 216 contains humic substances. Fulvic acid generally is the most abundant component of the aqueous liquid effluent 216. Other components of the effluent 216 include minerals, humates, fulvates, and salts formed during the organic composting process or the extraction process described herein. Humates are mineral salts formed with humic acid, and fulvates are mineral salts formed with fulvic acid. Thus, in addition to fulvic acid and humic acid, the resulting effluent contains many minerals and nutrients beneficial to plant growth and health. As mentioned previously, the resulting effluent 216 may also contain ammonium nitrate and other byproducts of the composting process.

FIG. 4 is a schematic flow chart diagram of another embodiment of a method and system for producing an aqueous liquid containing humic acid and fulvic acid, the method and system including a slurry mixture, a filter, and a separator.

The system and process described herein may also be modified in many different aspects to produce the desired product. For example, in one embodiment of the system and method, shown in FIG. 4, the slurry 313 may optionally pass through a strainer or filter 314 to remove the larger particulate solids prior to entrance of the slurry 313 into the separator 315. This enhances the ability of the separator 315 to separate the solid components from the liquid component by removing the larger solid components prior to passing through the separator 315. Any type of strainer can be employed to affect this filtering process.

In another embodiment, also shown in FIG. 4, the concentration of fulvic acid in the resulting aqueous liquid effluent 316 can be optimized by reusing the aqueous liquid effluent 316 in the system and process. In this embodiment, after the slurry 313 has passed through the separator 315 and the liquid component separated from the solid components, the aqueous liquid effluent 316 drawn off the separator 315 is re-mixed with organic compost mixture 312 or slurry 313 for separation of the solid components from the liquid component in the organic compost mixture 312 or slurry 313 by means of the separator 315. The organic compost mixture 312 that is re-mixed with the effluent may be new or additional organic compost mixture, or may be the original organic compost mixture drawn off from the separator.

In one embodiment, the aqueous liquid effluent 316 is added to the organic compost mixture 312 to achieve approximately a 3:1 ratio by weight of aqueous liquid effluent 316 to solid components prior to the second separation step. This ratio may be adjusted as necessary to achieve optimum results. In one embodiment, this second separation step can be carried out on a second separator. The additional separation step may also be carried out on any number of sequential separators until the desired concentration and composition of the resulting aqueous liquid effluent 316 is achieved. By repeating the separation step in the process and reusing the aqueous liquid effluent 316, the resulting concentration of fulvic acid in the aqueous liquid effluent 316 can be doubled or increased many times more than would result with only one pass through a separator 315.

In another embodiment, also shown in FIG. 4, the solid components 317 separated from the liquid component by the separator 315 may also be used or reused in various applications. In one embodiment, the resulting solids 317 are again combined with liquid 311 to create a slurry 313 that is then run through a separator 315 to separate out the humic substances, including fulvic acid, that remained in the solids and did not separate with the liquid effluent 316 during the prior separation. The same procedures as described above for reuse of the effluent 316 can be employed on the separated solid components 317. Indeed, this process may be repeated on the solid components 317 multiple times in order to achieve a maximum or desired extraction of the humic substances, including fulvic acid.

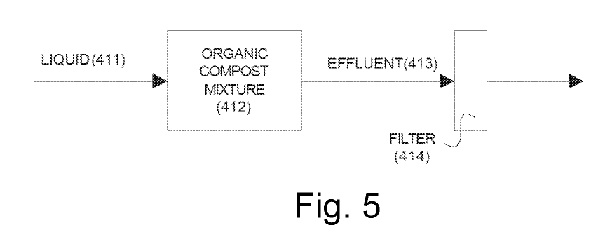

FIG. 5 is a schematic flow chart diagram of another embodiment of a method and system for producing an aqueous liquid containing humic acid and fulvic acid. In another aspect of the system and method, once the effluent containing humic substances, including fulvic acid, has been collected from the organic compost mixture, it can then be prepared for use. For example, in one embodiment shown in FIG. 5, the effluent 413 is filtered or strained by a filter 414 prior to use to remove any remaining large solid components. In one embodiment, the filter 414 comprises a 50 micron filter. However, any size and number of filters 414 may be employed, depending on the desired level of filtration of the effluent 413.

The effluent from the above-described extraction systems and methods results in an extraction product that contains a high concentration of humic substances, particularly fulvic acid, and beneficial plant nutrients. Generally, the composition of the final product includes fulvic acid, which in one embodiment comprises at least 4% of the total product by weight, and in one aspect comprises approximately 4% to 10%, and in another aspect comprises at least 7%, and in another aspect comprises approximately 7% to 10%. In one embodiment, the average mass of the fulvic acid molecules is between about 300 to about 2,000 daltons. In another embodiment, the average mass of the fulvic acid molecules is between about 500 to about 1,000 daltons. The product also comprises humic acid up to approximately 3% of the total product by weight, and in another aspect comprises humic acid at approximately 0.5% to approximately 2.5% by weight of the total product. In one embodiment, the average mass of the humic acid molecules is between about 2,000 to 150,000 daltons. In another embodiment, the average mass of the humic acid molecules is greater than 54,000 daltons.

The extraction systems, methods, and products described herein can be better understood with a description of the following examples. It should be noted, however, that the following examples are to serve only as illustrative examples and should in no way provide limitations to the extraction systems, methods, and products described herein.

### Example 1

An exemplary fulvic acid solution was prepared as follows. Water was combined with an organic compost mixture in the form and formulation of compost windrows formulated for mushroom growth. The compost windrows contained rye straw (85-90% by weight), chicken manure, peat, gypsum, and shaft from alfalfa seeds. Water was added to the exterior surface of compost windrows in amounts that exceeded the saturation level of the compost windrows. The excess water effluent that escaped out of the organic compost mixture windrows was collected in defined channels at the bases of the windrows. This water effluent was then passed through a 50 micron filter, and then treated to kill harmful pathogens by adding copper sulfate to the effluent. The resulting concentration of fulvic acid and humic acid, micronutrients, and macronutrients in the product was as shown in Table 1 below. The concentration of fulvic acid and humic acid were measured by spectrophotometric analysis.

TABLE 1

| Component | Concentration (ppm) |
|---|---|
| Fulvic Acid* | 9.25% |
| Humic Acid* | 0.77% |
| Phosphorous | 89.70 |
| Potassium | 7,290.00 |
| Calcium | 274.00 |
| Magnesium | 129.00 |
| Sulfur | 739.00 |
| Boron | 1.54 |
| Copper | 0.46 |
| Iron | 5.66 |
| Chlorine | 428.00 |
| Manganese | 0.76 |
| Molybdenum | 0.21 |
| Zinc | 1.89 |

*Concentration measured as % by weight

### Example 2

An exemplary fulvic acid solution was prepared as follows. Water was combined with an organic compost mixture in the form and formulation of organic compost material designed and used as a bed for mushroom growth. The organic compost material was generated from organic matter comprising rye straw (85-90% by weight), chicken manure, peat, gypsum, and shaft from alfalfa seeds. The organic compost material was used approximately 1-day after mushrooms growing on the bed were harvested. Water was mixed with the organic compost material to create a slurry. The slurry then passed through a centrifuge separator to separate the slurry's solid components from its liquid component. The resulting concentration of fulvic acid and humic acid in the liquid product was as shown in Table 2 below. The concentration of fulvic acid and humic acid were measured by spectrophotometric analysis.

TABLE 2

| | Concentration |
|---|---|
| Component | (% by weight) |
| Fulvic Acid | 7.19% |
| Humic Acid | 2.28% |

### Example 3

An exemplary fulvic acid solution was prepared as follows. Water was combined with an organic compost mixture in the form and formulation of organic compost material designed and used as a bed for mushroom growth. The organic compost material was generated from organic compost mixture containing rye straw (85-90% by weight), chicken manure, peat, gypsum, and shaft from alfalfa seeds. The organic compost material was used approximately 14-days after mushrooms growing on the bed were harvested. Water was mixed with the organic compost material to create a slurry. The slurry then passed through a centrifuge separator to separate the slurry's solid components from its liquid component. The resulting concentration of fulvic acid and humic acid in the liquid product was as shown in Table 3 below. The concentration of fulvic acid and humic acid were measured by spectrophotometric analysis.

TABLE 3

| | Concentration |
|---|---|
| Component | (% by weight) |
| Fulvic Acid | 8.71% |
| Humic Acid | 0.92% |

### Example 4

An exemplary fulvic acid solution was prepared as follows. Water was combined with an organic compost mixture in the form and formulation of organic compost material designed and used as a bed for mushroom growth. The organic compost material was generated from organic compost mixture containing rye straw (85-90% by weight), chicken manure, peat, gypsum, and shaft from alfalfa seeds. The organic compost material was used approximately 10-weeks after mushrooms growing on the bed were harvested. Water was mixed with the organic compost material to create a slurry. The slurry then passed through a belt press separator to separate the slurry's solid components from its liquid component. The resulting composition of the product was as shown in Table 4 below. The concentration of fulvic acid and humic acid were measured by spectrophotometric analysis.

TABLE 4

| Component | Concentration (ppm) |
|---|---|
| Fulvic Acid* | 9.06% |
| Humic Acid* | 0.51% |
| Phosphorous | 60.80 |
| Potassium | 18,900.00 |
| Calcium | 1,690.00 |
| Magnesium | 407.00 |
| Sulfur | 4,720.00 |
| Boron | 1.03 |
| Copper | 0.12 |
| Iron | 5.28 |
| Manganese | 1.18 |
| Molybdenum | 0.15 |
| Zinc | 0.39 |

### Example 5

An exemplary fulvic acid solution was prepared as follows. Water was combined with an organic compost mixture in the form and formulation of organic compost material designed and used as a bed for mushroom growth. The organic compost material was generated from organic compost mixture containing rye straw (85-90% by weight), chicken manure, peat, gypsum, and shaft from alfalfa seeds. Water was mixed with the organic compost material to create a slurry. The slurry then passed through a centrifuge separator to separate the slurry's solid components from its liquid component. The resulting concentration of fulvic acid in the liquid product was approximately 4% by weight. This liquid product was then reused by combining it with another similar organic compost mixture, which was then run through the centrifuge. The concentration of fulvic acid in the liquid product after the second separation in the centrifuge was approximately 7.6% by weight.

While the fluid that contains humic substances may be obtained using the various extraction processes, methods, and sources (such as coal and/or organic matter) described above, the fluid that contains humic substances may be ready for use in a variety of applications. Examples include, but are not limited to, fertilizer uses and livestock feeding supplements, among others. Further, the fluid containing humic substances may also be used to treat exhaust gas that contains emissions from a combustion process.

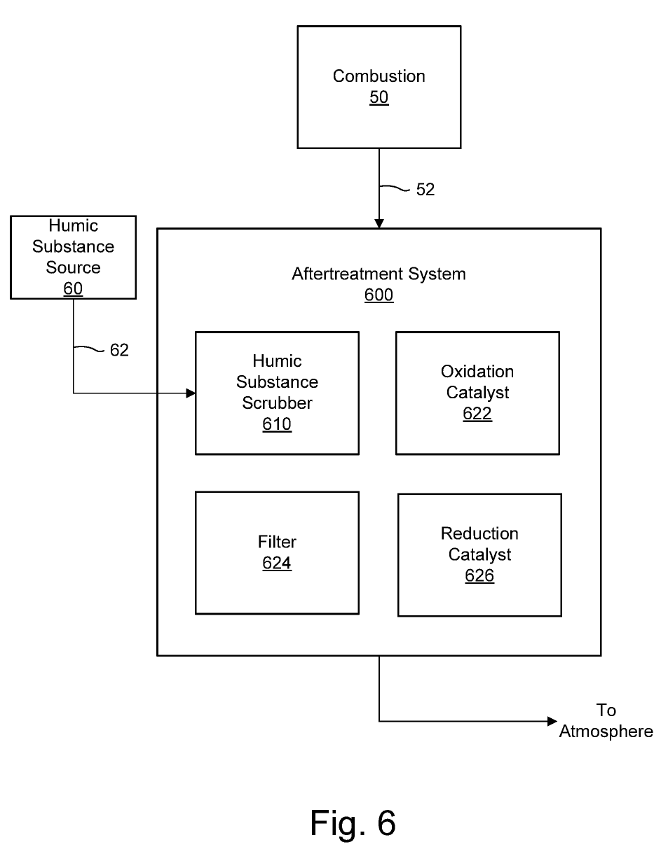

FIG. 6 is a schematic block diagram of one embodiment of an aftertreatment system 600 that includes a scrubber 610 that utilizes humic substances to wash an exhaust gas stream 52. In a combustion process 50, air from the atmosphere, or some other oxidant, is combined with a fuel, which is then combusted to provide power (via steam turbines coupled to electrical generators, movement of engine cylinders, etc.). Combustion of the fuel and air in the combustion chambers produces exhaust gas 52 that is operatively vented to an exhaust manifold or a flue. Before the exhaust gas is vented to the atmosphere, the exhaust gas may pass through an aftertreatment system 600.

Generally, emission requirements vary according to the type of combustion process and/or the type of fuel. For example, a stationary power generation facility, such as a coal power plant, may result in an exhaust gas stream that has different emissions properties than, for example, an internal combustion engine (gasoline or diesel). Generally, emission tests for combustion procedures typically monitor the release of carbon monoxide (CO), unburned hydrocarbons (UHC), diesel particulate matter (PM) such as ash and soot, and nitrogen oxides (NOx), among other emissions byproducts.

Various aftertreatment systems 600 can be implemented downstream of an exhaust gas stream 52 to mitigate the harmful effects of the emissions. In one embodiment, the aftertreatment system 600 is configured to remove emissions byproducts/pollutants from the exhaust gas stream 52. In another embodiment, the aftertreatment system may be used to react the emissions byproducts with reagents to yield less harmful emissions byproducts. Thus, the purpose of aftertreatment methods and systems is to decrease the harmful nature of the emissions byproducts that are released to the atmosphere. In another embodiment, the purpose of reformation methods and systems is to render the emissions byproducts more easily removable from the exhaust gas stream for subsequent disposal/reuse. The low mass of the humic substance molecules (see above regarding average mass of humic substance molecules) may contribute to the effectiveness of the humic substance molecules in treating the exhaust gas stream.

Examples of components in the aftertreatment system include, but are not limited to, catalytic converters, scrubbers, and filters. Oxidation catalysts 622, such as diesel oxidation catalysts, may be implemented in exhaust gas aftertreatment systems to oxidize at least some particulate matter in the exhaust stream, reduce unburned hydrocarbons and CO in the exhaust to less environmentally harmful compounds, and oxidize nitric oxide (NO) to form nitrogen dioxide (NO₂), which is used in the NOx conversion on an selective catalytic reduction (SCR) catalyst 626. To remove the particulate matter, a particulate matter (PM) filter 624 may be installed downstream from the oxidation catalyst or in conjunction with the oxidation catalyst 622. However, some exhaust aftertreatment systems do not have a PM filter 624. With regard to reducing NOx emissions, NOx reduction catalysts, including SCR systems, are utilized to convert NOx (NO and NO₂ in some fraction) to N₂ and other compounds.

Although the aftertreatment system in FIG. 6 is depicted as having multiple different components, it is expected that the humic substance scrubber 610 may be implemented either in conjunction with one or more of the various aftertreatment components 622, 624, 626 described above or independent of such components. In one embodiment, the scrubber 610 may be in fluid receiving communication with the exhaust gas stream 52 and the scrubber may rout a humic substance fluid 62 from a humic substance source 60 to be combined with the exhaust gas stream 52. The source of the humic substances 60 may be any of the various extraction methods and/or systems described above.

In one embodiment, the method described above with reference to FIG. 1 is utilized to provide the source of the humic substances 60. In other words, the source of the humic substances may an aqueous liquid that had been combined with heated compost material. The fluid containing the humic substances 62 may be a vapor stream that has been vaporized from a liquid stream. In one embodiment, the system may include a vaporizer, a nebulizer, an aspirator, an atomizer, a spray nozzle, an expansion valve, or a venturi pump, among others, that is configured to convert a liquid into a vapor or a mist that reacts with the emissions byproducts in the exhaust gas stream. The fluid stream of humic substances 60 is injected into the scrubber chamber via a nozzle or other similar mechanism.

The humic substances, which include humic acid and/or fulvic acid, may interact with the emissions byproducts in the exhaust gas stream in various manners. In one embodiment, the humic substances facilitate oxidation of the various pollutant byproducts in the exhaust gas stream, such as the oxidation of carbon monoxide (CO) and/or nitric oxide (NO). In another embodiment, the humic substances may facilitate the chelation of heavy metals or other similar pollutants in the exhaust gas stream. In one embodiment, the humic substances may be implemented to form coordination complexes with various pollutants. In other words, the humic substances may function as ligands or complexing agents and may facilitate surrounding and bonding with pollutant molecules, such as metal pollutants. In one embodiment, the humic substance scrubber(s) may be utilized to react and release reformed emissions byproducts into the atmosphere. In another embodiment, the humic substance scrubber(s) may be utilized to react and remove reformed emissions byproducts from the exhaust gas stream. In another embodiment, the humic substances that are combined with the exhaust gas stream may have other emissions mitigation effects.

For example, according to one embodiment the humic substances may facilitate at least the partial oxidation of methane in an exhaust gas stream. In one embodiment, the exhaust gas stream may be emitted during the production, refinement, processing, storage, transmission, and distribution of natural gas and/or petroleum. Thus, according to one embodiment, the exhaust gas stream may not be an emissions stream from a combustion process but instead may be an off-gas stream from a natural gas and/or petroleum collection, production, or refinement process.

In one embodiment, a single humic substance scrubber may be utilized in an aftertreatment system for a specific purpose. In another embodiment, multiple humic substance scrubbers may be implemented in various stages and among other aftertreatment components to facilitate exhaust gas reformation. The scrubber of the system may be configured to yield reformed emissions byproducts that precipitate out of the exhaust gas stream. In another embodiment, the scrubber is configured to yield reformed emissions byproducts that are insoluble in an aqueous liquid, such as a liquid drain-off effluent. The system may further include a separator that is configured to remove the reformed emissions byproducts from the exhaust gas stream.

In one embodiment, the scrubber may include a heater that is configured to heat the exhaust gas stream and the fluid stream comprising humic substances in order to improve the effectiveness, reaction rate, and chemical activity of the humic substances. In one embodiment, the heater heats the exhaust gas stream and the fluid stream comprising humic substances to at least about 170° F. In another embodiment, the heater heats the exhaust gas stream and the fluid stream comprising humic substances to at least about 220° F.

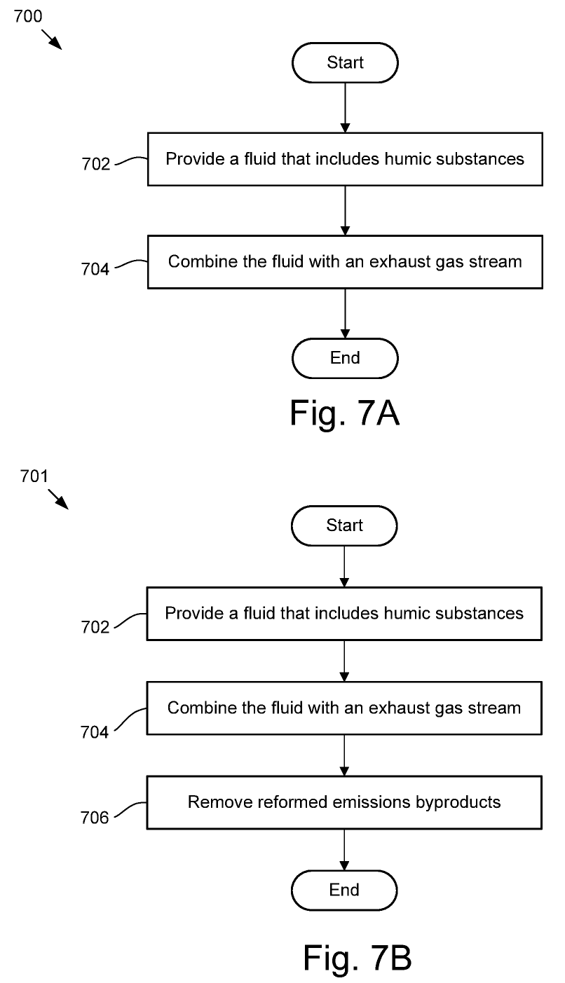

FIG. 7A is a schematic flow chart diagram of one embodiment of a method 700 for reforming an exhaust gas stream and FIG. 7B is a schematic flow chart diagram of another embodiment of a method 701 for reforming an exhaust gas stream. The method 700 includes providing 702 a fluid that contains humic substances and combining 704 the fluid with the exhaust gas stream. As described above, the exhaust gas stream includes emissions byproducts from a combustion process, wherein the humic substances in the fluid react with the emissions in the exhaust gas stream to yield reformed emissions byproducts. The method 700 may further include an additional step (i.e., a three step method 701). Such a method 701, in addition to the previously described steps, also includes removing 706 the reformed emissions byproducts, as described above, from the exhaust gas stream before venting the exhaust gas to the atmosphere.

In the above description, certain terms may be used such as “top,” “bottom,” “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, a “top” surface can become a “bottom” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Also, securing one element to another element can include direct and indirect securing. Additionally, as used herein, “adjacent” does not necessarily denote contact (i.e., one element can be adjacent to another without being in contact with the other).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The subject matter of the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method for reforming an exhaust gas stream, the method comprising:
providing a fluid comprising humic substances; and
combining the fluid with the exhaust gas stream, wherein the exhaust gas stream comprises emissions from a combustion process, wherein the humic substances in the fluid react with the emissions in the exhaust gas stream to yield reformed emissions byproducts.

2. The method of claim 1, wherein the fluid comprising humic substances is a liquid, wherein combining the liquid with the exhaust gas stream comprises vaporizing the liquid to form a vapor stream that comprises humic substances and introducing the vapor stream into the exhaust gas stream.

3. The method of claim 1, wherein the combustion process is a power plant.

4. The method of claim 1, wherein the combustion process is an internal combustion engine.

5. The method of claim 1, further comprising removing the reformed emissions byproducts from the exhaust gas stream.

6. The method of claim 1, wherein providing the fluid comprising humic substances comprises extracting a liquid effluent from organic compost material.

7. The method of claim 1, wherein providing the fluid comprising humic substances comprises:
providing an organic compost material;
combining the organic compost material with a crop;
after combining the organic compost material with a crop, heating the organic compost material;
after heating the organic compost material, combining the organic compost material with water; and
after combining the organic compost material with water, extracting the fluid comprising humic substances.

8. The method of claim 7, wherein the crop comprises mushroom spores and mycelia.

9. The method of claim 7, wherein heating the organic compost material comprises heating the organic compost material while the organic compost material is still combined with soil in which the crop is or was planted.

10. The method of claim 9, wherein heating comprises heating the organic compost material to at least 170° F.

11. The method of claim 9, wherein heating comprises heating the organic compost material to at least 200° F.

12. The method of claim 9, wherein heating comprises heating the organic compost material to at least 220° F.

13. A method for reforming an exhaust gas stream, the method comprising:
providing an organic compost material;
combining the organic compost material with a crop;
after combining the organic compost material with a crop, heating the organic compost material;
after heating the organic compost material, combining the organic compost material with water;
after combining the organic compost material with water, extracting the fluid comprising humic substances; and
combining the fluid comprising humic substances with the exhaust gas stream, wherein the exhaust gas stream comprises emissions from a combustion process, wherein the humic substances in the fluid react with the emissions in the exhaust gas stream to yield reformed emissions byproducts.

14. A system for reforming an exhaust gas stream, the system comprising:
a vaporizer configured to vaporize a liquid that comprises humic substances to form a vapor stream that comprises humic substances; and
a scrubber in fluid receiving communication with the exhaust gas stream, wherein the exhaust gas stream comprises emissions from a combustion process, wherein the scrubber is configured to wash the exhaust gas stream with the vapor stream to yield reformed emissions byproducts.

15. The system of claim 14, wherein the vaporizer is selected from the group consisting of: a nebulizer, an aspirator, an atomizer, a spray nozzle, an expansion valve, and a venturi pump.

16. The system of claim 14, wherein the scrubber is configured to yield reformed emissions byproducts that precipitate out of the exhaust gas stream.

17. The system of claim 14, wherein the scrubber is configured to yield reformed emissions byproducts that are insoluble in an aqueous liquid.

18. The system of claim 14, further comprising a separator configured to remove the reformed emissions byproducts from the exhaust gas stream.

19. The system of claim 14, wherein the scrubber comprises a heater configured to heat the exhaust gas stream and the vapor stream comprising humic substances to at least about 170° F.

20. The system of claim 19, wherein the heater is configured to heat the exhaust gas stream and the vapor stream comprising humic substances to at least about 220° F.
